(19) United States
(12) Patent Application Publication
(10) Pub. No.: US 2005/0140300 A1
(43) Pub. Date: Jun. 30, 2005

(54) Plasma display panel

(76) Inventor: Dae Hyun Park, Gwacheon-si (KR)

Correspondence Address: FLESHNER & KIM, LLP, P.O. BOX 221200, CHANTILLY, VA, 20153, US

(21) Appl. No.: 11/019,463

(22) Filed: Dec. 23, 2004

(30) Foreign Application Priority Data
Dec. 24, 2003 (KR) 10-2003-0096211

(51) Int. Cl. H01J 17/49

(52) U.S. Cl. 313/586

(57) ABSTRACT

The present invention relates to a plasma display panel and, more particularly, to a PDP in which surface separation lines are not generated. According to an embodiment of the present invention, a plasma display panel having a dielectric layer, which is formed by laminating a green sheet and the panel, wherein the green sheet comprises a glass powder, a dispersing agent, a binder, a plasticizer and a surfactant. Therefore, if a panel having a dielectric layer is fabricated by using a green sheet according to the present invention, separation lines are not generated. Accordingly, the present invention is advantageous in that it needs not additional equipment and process for preventing generation of separation lines, and it can reduce a manufacture time and cost.

This Nonprovisional application claims priority under 35 U.S.C. § 119(a) on Patent Application No. 10-2003-0096211 filed in Korea on Dec. 24, 2003, the entire contents of which are hereby incorporated by reference.

### BACKGROUND OF THE INVENTION

1. Field of the Invention

The present invention relates to a plasma display panel (hereinafter, referred to as “PDP”) and, more particularly, to a PDP in which surface separation lines are not generated.

2. Description of the Background Art

It has been known that most image display devices are implemented by employing liquid crystal display, electroluminescence display or plasma display. Of those image display devices, the PDP using employing plasma display has recently been spotlighted. In order to meet the need for the high quality, low-power consumption, slimness, low price, etc., a variety of improvements have been examined.

FIG. 1 is cross-sectional view illustrating an example of the structure of a PDP.

Referring to FIG. 1, the PDP includes a pair of glass substrates composed of a glass substrate 1 for a front surface plate from which light emits and a glass substrate 2 for a rear surface plate. A sustain electrode 3 and an address electrode 4, which are orthogonal to each other, are formed on the inner surface of the glass substrates 1, 2, respectively. The sustain electrode 3 and the address electrode 4 are covered with a transparent dielectric layer 5 and a white dielectric layer 6, respectively. Furthermore, a protection film 7 is formed on the transparent dielectric layer 5. Discharge spaces (pixels), which are separated by barrier ribs 8, are formed between the glass substrates 1 and 2. Phosphors 9 are provided every pixel.

In order to realize a high quality PDP, the transparent dielectric layer 5 and the white dielectric layer 6 must have a uniform thickness and a flat surface. If the uniformity and the surface flatness of the dielectric layer are insufficient, there is a possibility that display defects are generated in a PDP because the insulating property of the dielectric layer cannot be maintained or the dielectric property is irregular.

Furthermore, in order for cell defects not to be generated by a voltage upon discharge of a PDP, the dielectric layer has to have a good withstand voltage property. A dielectric layer of a PDP must have the withstand property against a voltage of 0.5 kV or over.

The process of manufacturing a panel in PDP mainly includes a process of fabricating and mating an upper plate and a lower plate, an exhaust process, a gas injection process and a sealing process. Each of the processes is composed of unit processes. In order to accomplish the above-described technical subjects, it is essential to secure a shape design of electrodes, dielectrics and barrier ribs, composition design of inert gases such as He, Ne and Xe, process technologies for efficiently forming a PDP structure, and a low cost material efficient in PDP driving.

Of the above processes, a method of forming a dielectric thick film, which serves as an electric protect layer of an upper plate, is classified into a printing method using screen printing of paste, and a method by lamination of a green sheet. Of them, the method of forming the thick film through lamination of the green sheet has recently been researched a lot because the thick film can be pre-fabricated in a dry film shape and the number of a process can be reduced accordingly.

The dielectric layer is formed by forming a coating layer of a dielectric material on a glass substrate and then sintering the coating layer. Accordingly, the coating layer formed on the glass substrate has to be uniform and flat. As an example of a coating method, a screen printing method has been known. In forming the dielectric layer by the screen printing method, a process in which paste containing glass frit and resin is printed on a glass substrate and is then dried is repeatedly carried out. Finally, by sintering the coating layer formed on the glass substrate, the dielectric layer is formed.

However, since the screen printing method is a wet method, a film thickness of a coating layer, which can be formed at once, is limited. Furthermore, thick filming of the coating layer requires a multi-printing process in which paste is printed, a solvent is volatilized, and the paste is printed. For this reason, the work efficiency is bad and there is a possibility that a solvent may remain in coating. As a result, there are problems in that the cost necessary for coating increases, the remaining solvent has a bad influence on the coating layer, and the performance of the dielectric layer may be degraded.

Furthermore, when forming a dielectric film of a PDP upper plate, the process of forming paste through screen printing requires several printing and dry processes so as to obtain a desired thickness. Thus, there is a problem in that the number of a process increases.

In consideration of this circumstance, several methods of forming a dielectric material on a substrate have been reported. For example, Japanese Patent Laid-Open Publication No. 61-22682 discloses a method of forming a glazed ceramic substrate in which a glass layer is formed on the ceramic substrate. In this method, a glass layer is formed on a ceramic substrate by means of processes in which a dispersing material containing glass frit or glazable material is formed on a belt or the film to form a green sheet containing glass frit or a glazable material, compressing the obtained green sheet onto a ceramic substrate, and then heating the results so that the green sheet is melted and fixed to the ceramic substrate. In this method, however, there is a problem in that an adhesive force of the green sheet against the ceramic substrate is weak.

Furthermore, the method by lamination of the existing green sheet has a problem in that separation lines are generated because of variation in the process speed in stripping the protect film during the lamination process.

FIG. 2 shows a state where separation lines are generated in the method by laminating using a conventional green sheet.

As shown in FIG. 2, it is common that a base film 105 is laminated on the top surface of a green sheet 101 and a cover film 103 is laminated on the bottom surface of the green sheet so as to protect the sheet. In this time, the laminated film for protection is stripped with it is laminated together with the upper plate glass panel. In the process of stripping the cover film, however, if the strip speed is changed or temporarily stopped, lines (separation lines) are generated on the surface of the sheet, which is laminated together with the cover film. The generated separation lines remain even after the sheet is sintered, and thus serve as a factor to degrade the quality of the panel.

### SUMMARY OF THE INVENTION

Accordingly, an object of the present invention is to solve at least the problems and disadvantages of the background art.

An object of the present invention is to provide a plasma display panel including a green sheet not having surface separation lines, which are generated when a film for protection is stripped after lamination, in the case where the green sheet is employed in a dielectric formation process upon manufacture of a PDP upper plate.

According to an embodiment of the present invention, there is provided a plasma display panel having a dielectric layer, which is formed by laminating a green sheet and the panel, wherein the green sheet comprises a glass powder, a dispersing agent, a binder, a plasticizer and a surfactant.

A green sheet according to an embodiment of the present invention is used for fabricating a plasma display panel. The green sheet includes a glass powder, a dispersing agent, a binder and a plasticizer, and further includes a surfactant.

Aaccording to the present invention, if a panel having a dielectric layer is fabricated by using a green sheet according to the present invention, separation lines are not generated. Accordingly, the present invention is advantageous in that it needs not additional equipment and process for preventing generation of separation lines, and it can reduce a manufacture time and cost.

### BRIEF DESCRIPTION OF THE DRAWINGS

The invention will be described in detail with reference to the following drawings in which like numerals refer to like elements.

FIG. 1 is cross-sectional view illustrating an example of the structure of a PDP.

FIG. 2 shows a state where separation lines are generated in a method by laminating using a conventional green sheet.

FIG. 3 is a cross-sectional view of a green sheet according to an embodiment of the present invention.

FIG. 4 is a schematic view illustrating a common lamination method.

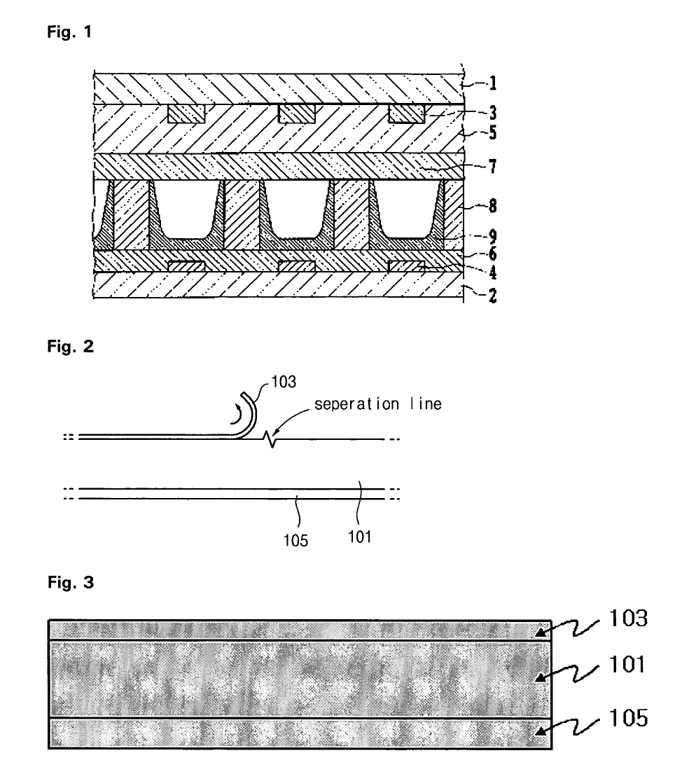

### DETAILED DESCRIPTION OF PREFERRED EMBODIMENTS

Preferred embodiments of the present invention will be described in a more detailed manner with reference to the drawings.

According to an embodiment of the present invention, there is provided a plasma display panel having a dielectric layer, which is formed by laminating a green sheet and the panel, wherein the green sheet comprises a glass powder, a dispersing agent, a binder, a plasticizer and a surfactant.

The green sheet, which is used to fabricate the plasma display panel according to an embodiment of the present invention, includes the surfactant. If the surfactant is contained in the green sheet, a mold release force, which is necessary to strip a film for protection after lamination, can be reduced. Surface separation lines are thus not generated even after the stripping.

The surfactant can be a fluorine-based compound or a silicon-based compound. In either case, the same effect can be obtained.

In the green sheet, the composition ratio of the surfactant is from 0.1% to 2%. If the green sheet containing the surfactant having this composition ratio is used, generation of surface separation lines can be prohibited when stripping the film for protection.

A green sheet according to an embodiment of the present invention is used for fabricating a plasma display panel. The green sheet includes a glass powder, a dispersing agent, a binder and a plasticizer, and further includes a surfactant.

The green sheet according to an embodiment of the present invention further contains a surfactant. If the surfactant is contained in the green sheet, a mold release force necessary to strip a film for protection after lamination can be reduced. Surface separation lines are thus not generated even after the stripping.

The surfactant can be a fluorine-based compound or a silicon-based compound. In either case, the same effect can be obtained.

In the green sheet, the composition ratio of the surfactant is from 0.1% to 2%. If the green sheet containing the surfactant having this composition ratio is used, generation of surface separation lines can be prohibited when stripping the film for protection.

Hereinafter, embodiments of the present invention will be described in a more detailed manner with reference to the drawings.

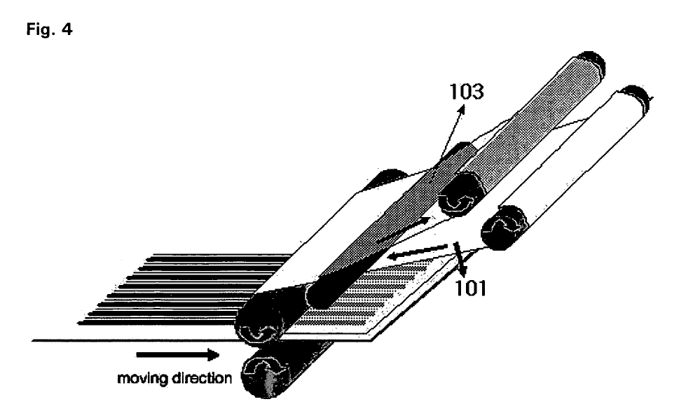

FIG. 3 is a cross-sectional view of a green sheet according to an embodiment of the present invention. FIG. 4 is a schematic view illustrating a common lamination method.

As shown in FIG. 3, according to the present invention, a film for protection 103 is laminated on the top surface of a green sheet 101 and a film for protection 105 is laminated on bottom surface of the green sheet 101.

As shown in FIG. 4, the aforementioned green sheet is laminated on a glass panel while mold-releasing the film for protection 103. In this time, during time between panels, the speed that the cover film is stripped in the sheet is reduced or temporarily stopped. Straight separation lines are generated on the surface of the sheet due to variation in the speed. In this time, the generated separation lines remain even after the sintering of the sheet, and thus act as a factor to degrade the quality of the panel.

One of the factors, which generate these separation lines, is a sticking force between the green sheet and the cover film, i.e., the mold release force when the cover film is stripped from the sheet. This can be generally considered as surface chemistry at different two interfaces.

In order to solve this problem, the present invention employs a surfactant so as to surface energy at two interfaces. Furthermore, upon fabrication of the green sheet, a green sheet composition containing a given amount of a surface active component is used.

The green sheet according to the present invention includes the surfactant having a composition ratio of from 0.1% to 2%.

If the green sheet having this composition is employed, surface separation lines are not generated in stripping the film for protection after lamination.

As described above, according to the present invention, if a panel having a dielectric layer is fabricated by using a green sheet according to the present invention, separation lines are not generated. Accordingly, the present invention is advantageous in that it needs not additional equipment and process for preventing generation of separation lines, and it can reduce a manufacture time and cost.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A plasma display panel having a dielectric layer, which is formed by laminating a green sheet and the panel,
wherein the green sheet comprises a glass powder, a dispersing agent, a binder, a plasticizer and a surfactant.

2. The plasma display panel as claimed in claim 1, wherein the surfactant is a fluorine-based compound.

3. The plasma display panel as claimed in claim 1, wherein the surfactant is a silicon-based compound.

4. The plasma display panel as claimed in claim 1, wherein the composition ratio of the surfactant in the green sheet is from 0.1% to 2%.

5. The plasma display panel as claimed in claim 2, wherein the composition ratio of the surfactant in the green sheet is from 0.1% to 2%.

6. The plasma display panel as claimed in claim 3, wherein the composition ratio of the surfactant in the green sheet is from 0.1% to 2%.

7. A green sheet used to fabricate a plasma display panel,
wherein the green sheet comprises a glass powder, a dispersing agent, a binder and a plasticizer, and further comprises a surfactant.

8. The green sheet as claimed in claim 7, wherein the surfactant is a fluorine-based compound.

9. The green sheet as claimed in claim 7, wherein the surfactant is a silicon-based compound.

10. The green sheet as claimed in claim 7, wherein the composition ratio of the surfactant in the green sheet is from 0.1% to 2%.

11. The green sheet as claimed in claim 8, wherein the composition ratio of the surfactant in the green sheet is from 0.1% to 2%.

12. The green sheet as claimed in claim 9, wherein the composition ratio of the surfactant in the green sheet is from 0.1% to 2%.
